(19) United States
(12) Patent Application Publication
(10) Pub. No.: US 2003/0030287 A1
(43) Pub. Date: Feb. 13, 2003

(54) Latch mechanism

(76) Inventor: Sidney E. Fisher, Redditch (GB)

Correspondence Address: CARLSON, GASKEY & OLDS, P.C., 400 WEST MAPLE ROAD, SUITE 350, BIRMINGHAM, MI, 48009, US

(21) Appl. No.: 10/214,468

(22) Filed: Aug. 7, 2002

(30) Foreign Application Priority Data
Aug. 10, 2001 (GB) GB 0119508.0

(51) Int. Cl. E05C 3/06; E05C 3/16

(52) U.S. Cl. 292/216; 292/200

(57) ABSTRACT

A door latch mechanism for a vehicle includes a latch bolt movable between an open and a closed position, a pawl that releasably engages with the latch bolt at the first and second regions, and a release member, such as a release lever, that is connected to a door release handle. The release lever is prevented from disengaging the pawl from the latch bolt when the latch bolt is in the open position.

### CROSS REFERENCE TO RELATED APPLICATIONS

This application claims priority to United Kingdom (GB) patent application number 0119508.0 filed on 10 Aug. 2001.

### TECHNICAL FIELD

The present invention relates to a latch mechanism. More particularly, the present invention relates to a latch mechanism for motor vehicles.

### BACKGROUND OF THE INVENTION

A typical door latch mechanism essentially comprises a rotatable claw mounted on the vehicle door which co-operates with a striker pin mounted on the vehicle body. The action of closing the door causes the claw to rotate to a closed position whereupon it engages and retains the striker pin. The claw is maintained in a closed position by a sprung pawl which abuts an appropriately shaped portion of the claw. The latch typically includes a claw return spring which holds the claw in an open position ready to receive the striker pin before the door is closed.

It is desirable to eliminate this return spring so as to reduce the number of components in the latch mechanism and consequently make the latch mechanism cheaper and easier to manufacture. Further, the latch mechanism assembly can be made smaller, or alternatively the space vacated by elimination of the spring used to house one or more other components of the latch assembly.

However, the absence of a spring means that an alternative means must be provided to ensure that the claw cannot be caused to rotate when in its open position (except by engagement of the striker pin therewith in the usual manner). This may otherwise cause a failure of the latch mechanism to latch when a user attempts to close the door subsequently.

### SUMMARY OF THE INVENTION

The present invention seeks to overcome, or at least mitigate the aforesaid problem.

One aspect of the present invention provides a door latch mechanism for a vehicle comprising a latch bolt movable between an open and a closed position, a pawl arranged, in use, so as to be capable of releasably engaging the latch bolt at first and second regions corresponding to the open and closed positions respectively, and a release means, wherein the mechanism is arranged such that the release means is incapable of causing disengagement of the pawl from the latch bolt when the latch bolt is in the open position.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWING

FIG. 1 which is a diagrammatic side view of a latch mechanism according to one embodiment of the present invention.

### DETAILED DESCRIPTION OF THE PREFERRED EMBODIMENT

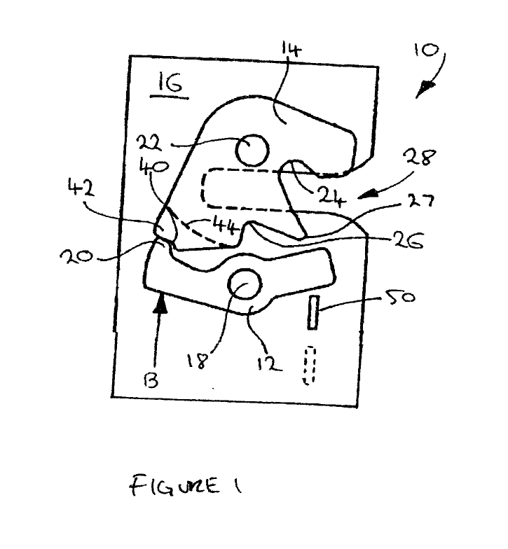

Referring to FIG. 1 there is shown a latch mechanism generally designated 10. The mechanism 10 includes a pawl 12, a latch bolt in the form of a claw 14, and a retention plate 16. The pawl 12 is pivotally mounted adjacent the claw 14 via a pawl pin 18 which is in turn connected to the retention plate 16. The pawl 12 includes a pawl engagement portion 20.

The retention plate 16, in conjunction with further components of the latch mechanism 10 (not shown) which do not move relative to the retention plate 16 during use, form a chassis of the latch mechanism 10.

The claw 14 is pivotally mounted on a claw pin 22 which is secured to the retention plate 16. The claw 14 includes a claw jaw 24 and a claw first safety engagement portion 26 and a claw closed engagement portion 27. In FIG. 1 the claw 14 is shown in an open position. The retention plate 16 includes a mouth 28 adapted to receive a striker pin (not shown).

In use, the claw jaw 14 releasably secures the striker pin in the mouth 28 of the retention plate 16. The claw 14 can be secured in its first safety position, by abutment of the pawl engagement portion 20 with the claw first safety engagement portion 26 wherein an associated door is secured from opening though is not in a fully closed position, and the claw can be secured in its closed position, by abutment of the pawl engagement portion 20 with the claw closed engagement portion 27.

The claw 14 is held in the open position in this embodiment by the provision of a detent mechanism. The detent mechanism is provided by the pawl engagement portion 20 and an appropriately shaped pawl recess 40 on an edge of the claw 14. In other classes of embodiment, the recess may be provided at an appropriate location on the pawl with a corresponding projection being provided on the claw.

As can be seen from FIG. 1, the pawl recess 40 is provided in an extended lobe 42 of the claw 14, the profile of a typical claw being shown by broken line 44. A resilient force, indicated by arrow B, to retain the pawl engagement portion 20 in the pawl recess 40, and hence the claw 14 in the open position, is provided by the pawl spring (not shown). It will be understood that the profile of the pawl recess 40 is such that the pawl engagement portion 20 is released therefrom when the claw 14 is caused to rotate to the closed position.

It should be noted that the radial distance between the centre of the claw pin 22 and the recess 40 is greater than the radial distance between the claw pin 22 and the first safety and claw closed engagement portions 26 and 27. The recess 40 defines a first region of the claw and the portions 26 and 27 define a second region.

The latch mechanism further comprises a release means in the form of a release lever 50 operably connected to an inside and/or outside door release handle (not shown), and in some embodiments a power unlatching actuator (not shown). In FIG. 1, the end of the lever is shown, with the longitudinal axis thereof extending into/out of the paper. The solid outline of the lever indicates the extreme position thereof in which a latch user is actuating either the inside or outside release handle. The position indicated in broken lines relates to the rest position of the lever.

It is apparent from FIG. 1 that, at its full extent, the lever 50 is incapable of engaging the pawl 12 meaning that the pawl engagement portion 20 cannot be disengaged and the claw is thus substantially prevented from rotating unless the striker enters mouth 28.

However, due to the smaller radial distance between the first safety and claw closed engagement portions 26 and 27, once the pawl engages either of these portions, the release lever is now capable of engaging and releasing the pawl which in turn enables the striker to be released and the associated door to be opened.

It should be understood that numerous changes may be made within the scope of the embodiment. For example, alternative configurations of pawl and release lever may be employed, provided that the release lever is incapable of actuating the pawl when the pawl engagement portion is resting in the pawl recess. In alternative embodiments, the detent mechanism may be dispensed with, the claw being retained in an open position by frictional resistance induced between the pawl and the claw by virtue of the resilient force B provided by the pawl spring acting on the pawl.

It should be understood that various alternatives to the embodiments of the invention described herein may be employed in practicing the invention. It is intended that the following claims define the scope of the invention and that the method and apparatus within the scope of these claims and their equivalents be covered thereby.

1. A door latch mechanism for a vehicle comprising:
a latch bolt movable between an open and a closed position, the latch bolt having a first region corresponding to the open position and a second region corresponding to the closed position;
a pawl that releasably engages with the latch bolt at the first and second regions; and
a release means disposed in the mechanism to selectively disengage the pawl from the latch bolt, wherein the release means is prevented from disengaging the pawl from the latch bolt when the latch bolt is in the open position.

2. A latch mechanism according to claim 1, wherein the latch bolt is a rotatable claw that rotates about a center of rotation.

3. A latch mechanism according to claim 1, wherein the engagement occurs between the pawl and an edge of the latch bolt.

4. A latch mechanism according to claim 2, wherein a radial distance from the center of rotation of the claw to the first region is greater than a radial distance from the center of rotation of the claw to the second region.

5. A latch mechanism according to claim 1, wherein the release means is a release lever.

6. A latch mechanism according to claim 1, wherein the release means is selectively engageable with the pawl to cause disengagement of the pawl from the latch bolt, wherein the release means is engageable with the pawl when the latch bolt is in the closed position and wherein the release means is not engageable with the pawl when the latch bolt is in the open position.

7. A latch mechanism according to claim 6 wherein the release means approaches the pawl without contacting with the pawl when the latch bolt is in the open position.

8. A latch mechanism according to claim 1, wherein the pawl has a pawl recess and the latch bolt includes a pawl engagement portion that cooperates with the pawl recess to form a detent mechanism, wherein the detent mechanism releasably retains the latch bolt in the open position.

9. A latch mechanism according to claim 1, wherein frictional resistance between the pawl and the first region retains the latch bolt in the open position.

10. A latch mechanism according to claim 9, further comprising a resilient means acting on the pawl to induce the frictional resistance.
